(19) United States
(12) Patent Application Publication
(10) Pub. No.: US 2016/0056622 A1
(43) Pub. Date: Feb. 25, 2016

(54) THERMAL PROTECTION DEVICE AND METHOD FOR PROTECTING A MOTOR

(71) Applicant: Regal Beloit America, Inc., Beloit, WI (US)

(72) Inventors: Katie D. Hamilton, Covington, OH (US); Darrel Clyde Buttram, Crane, MO (US); Paul Steven Mullin, Yellow Springs, OH (US); William Arthur Ziegler, Jefferson City, MO (US)

(21) Appl. No.: 14/464,082

(22) Filed: Aug. 20, 2014

(51) Int. Cl. H02H 7/085; H02H 7/08

(52) U.S. Cl. CPC H02H 7/0852; H02H 7/0833

(57) ABSTRACT

A thermal protection device and methods for protecting a motor are described. The thermal protection device is electrically coupled between a power supply and a gate drive circuit for driving the motor. The thermal protection device is configured to disconnect the power supply from the gate drive circuit when a temperature measured by the thermal protection device exceeds a threshold temperature value.

### BACKGROUND

The field of the disclosure relates generally to motors, and more particularly, to a thermal protection device and methods for protecting a motor.

At least some known electric motors include thermal protection devices configured to terminate operation of the motor in response to thermal overload conditions, which could result in permanent damage to the motor and/or associated equipment. A thermal overload, such as an excessively high winding or rotor temperature, may occur as a result of a locked rotor, a high mechanical load, a supply overvoltage, a high ambient temperature, and/or some combination of these conditions. Such thermal protection devices are typically coupled between a motor power supply and the motor windings to protect against excessive heat buildup in the windings as current flows therethrough. As current flows and heats the windings, current also flows through the thermal protection device, causing it to heat up. When the thermal protection device reaches a pre-determined temperature, the device opens or “trips” and disconnects the windings from the motor circuit to prevent damage to the motor. As the thermal protection device cools, it eventually closes or “resets” and completes the motor circuit to energize the windings. As current flows through the thermal protection device and the windings, heat generated by the current flowing through the device causes the thermal protector to trip and again open the circuit, and as the thermal protector device cools it again resets and closes the circuit. Hence the thermal protector device cycles motor power on and off to prevent overheating of the motor in use.

Moreover, the spacing between the motor windings and the electronic control board of the motor may cause large temperature differentials, resulting in an inaccurate temperature sensing. An on-winding motor protection device interrupts power and accurately reacts to excessive temperatures. Most commercially available on-winding motor protectors are rated for low (less than about 600V) AC voltages or very low (less than about 50V) DC voltages. Many electronic motor controls utilize power switching to rapidly switch the DC voltage very fast to create an effective AC power. Such switched DC voltages exceed the power ratings of most commercially available thermal protectors.

### BRIEF DESCRIPTION

In one aspect, a thermal protection device is described. The thermal protection device is electrically coupled between a power supply and a gate drive circuit for driving the motor. The thermal protection device is configured to disconnect the power supply from the gate drive circuit when a temperature measured by the thermal protection device exceeds a threshold temperature value.

In another aspect, a method of protecting a motor is provided. The method includes electrically coupling a thermal protection device between a power supply and a gate drive circuit for driving the motor. The method also describes disconnecting, using the thermal protection device, the power supply from the gate drive circuit when a temperature measured by the thermal protection device exceeds a threshold temperature value.

In another aspect, a motor controller configured to be coupled to a motor is provided. The motor controller includes a gate drive circuit and a thermal protection device. The gate drive circuit is configured to receive power from a power supply and output a switching signal. The thermal protection device electrically coupled between the power supply and the gate drive circuit. The thermal protection device is configured to disconnect the power supply from the gate drive circuit when a temperature measured by the thermal protection device exceeds a threshold temperature value.

### BRIEF DESCRIPTION OF THE DRAWINGS

FIG. 1 is an exploded view of an exemplary motor assembly.

FIG. 2 is a block diagram of an exemplary motor assembly 200 that includes thermal protection device 59 (shown in FIG. 1).

### DETAILED DESCRIPTION

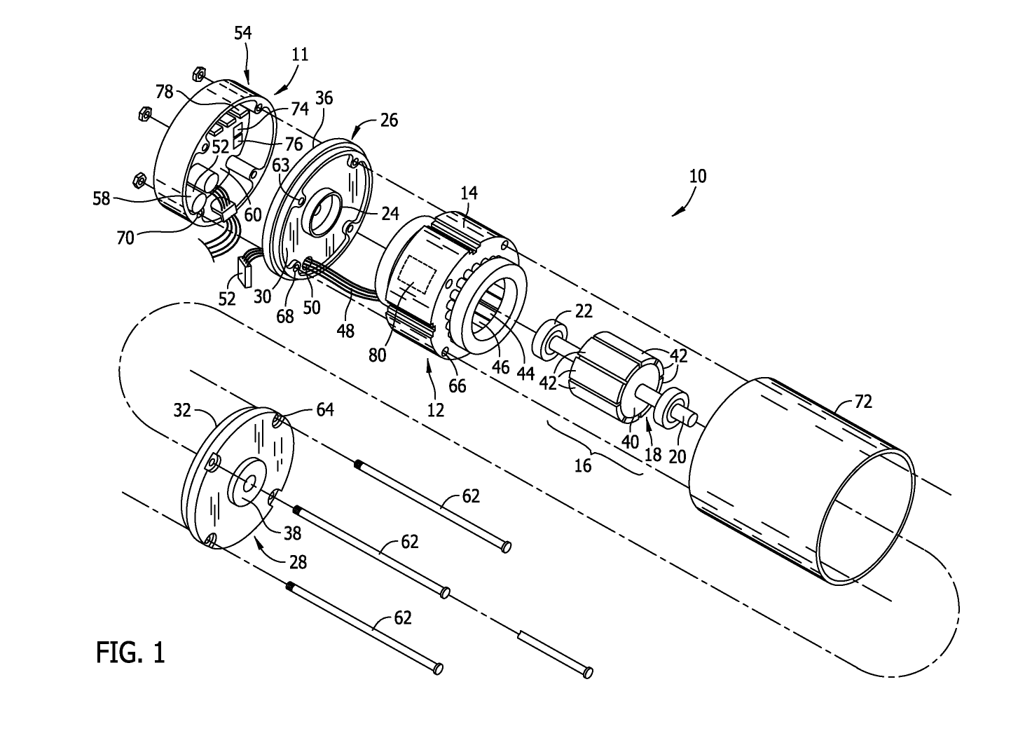

FIG. 1 is an exploded view of an exemplary motor 10. Motor 10 may be an electric motor and, in some implementations, is an electric variable speed motor, such as an electronically commutated motor (ECM). In the exemplary embodiment, motor 10 is a brushless electronically commutated DC motor having a stationary assembly 12 including a stator or core 14 and a rotatable assembly 16 including a permanent magnet rotor 18 and a shaft 20. A fan (not shown) or other means to be driven such as means for moving air through an air handling system engages shaft 20. Specifically, motor 10 may be used, for example, in a heating, ventilation, and air conditioning (HVAC) system, or, in other implementations, in an aquatic system, such as a pool or spa. While ECMs are utilized as examples throughout this disclosure, those of skill in the art will understand that the applications are equally adaptable to applications that utilize other devices that utilize a DC voltage supply, including, but not limited to, variable speed induction motors (VSIMs) and switched reluctance motors (SRMs), which are collectively referred to as direct current (DC) motors.

In the exemplary embodiment, rotor 18 is mounted on and keyed to shaft 20 journaled for rotation in conventional bearings 22. Bearings 22 are mounted in bearing supports 24 integral with a first end member 26 and a second end member 28. End members 26 and 28 have inner facing sides 30 and 32 between which stationary assembly 12 and rotatable assembly 16 are located. Each end member 26 and 28 has an outer side 34 and 36 opposite its inner side 30 and 32. Additionally, second end member 28 has an aperture 38 for shaft 20 to extend through outer side 34.

In the exemplary embodiment, rotor 12 includes a ferromagnetic core 40 and is rotatable within stator 14. Segments 42 of permanent magnet material, each providing a relatively constant flux field, are secured, for example, by adhesive bonding to rotor core 40. Segments 42 are magnetized to be polarized radially in relation to rotor core 40 with adjacent segments 42 being alternately polarized as indicated. While magnets on rotor 18 are illustrated for purposes of disclosure, it is contemplated that other rotors having different constructions and other magnets different in number, construction, and flux fields may be utilized with such other rotors within the scope of the invention.

Stationary assembly 15 includes a plurality of winding stages 44 adapted to be electrically energized to generate an electromagnetic field. Stages 44 are coils of wire wound around teeth 46 of laminated stator core 14. Winding terminal leads 48 are brought out through an aperture 50 in first end member 26 terminating in a connector 52. While stationary assembly 12 is illustrated for purposes of disclosure, it is contemplated that other stationary assemblies of various other constructions having different shapes and with different number of teeth may be utilized within the scope of the invention.

Motor 10 further includes an enclosure 54 which mounts on the rear portion of motor 10 to enclose control system 11 for motor 10 within enclosure 54. Control system 11 includes a plurality of electronic components 58 and a connector (not shown) mounted on a component board 60, such as a printed circuit board. Control system 11 applies a voltage to one or more of winding stages 44 at a time for commutating winding stages 44 in a preselected sequence to rotate rotatable assembly 16 about an axis of rotation.

Connecting elements 62 include a plurality of bolts that pass through bolt holes 64 in a second end member 28, bolt holes 66 in core 14, bolt holes 68 in a first end member 26, and bolt holes 70 in enclosure 54. Connecting elements 62 are adapted to urge second end member 28 and enclosure 54 toward each other thereby supporting first end member 26, stationary assembly 12, and rotatable assembly 16 therebetween. Additionally, a housing 72 is positioned between first end member 26 and second end member 28 to facilitate enclosing and protecting stationary assembly 12 and rotatable assembly 16.

In the exemplary embodiment, control system 11 includes at least one computing device 74, for example a microcontroller or a microprocessor, configured to control output signals from control system 11 for controlling the operating characteristics of motor 10. Control system 11 also includes a gate drive circuit 76 electrically coupled to and configured to control at least one power switch 78 based on instructions received from computing device 74.

In the exemplary embodiment, motor 10 further includes at least one thermal protection device 80 positioned adjacent to at least one of winding stages 44 and electrically coupled between a power supply (not shown) and to control system 11. Because protection devices configured for high voltage operation (i.e., greater than about 100V) are costly and uneconomical, thermal protection device 80 is configured for low voltage operation (i.e., less than about 600V AC or less than about 50V DC). Thermal protection device 80 is configured to sense a temperature of winding stage 44 and disconnect control system 11 from its power supply when the temperature exceeds a predefined threshold, as described in more detail herein.

Motor 10 may include any even number of rotor poles and the number of stator poles are a multiple of the number of rotor poles. For example, the number of stator poles may be based on the number of phases. In one embodiment (not shown), a three-phase motor 10 includes six rotor pole pairs and stator poles.

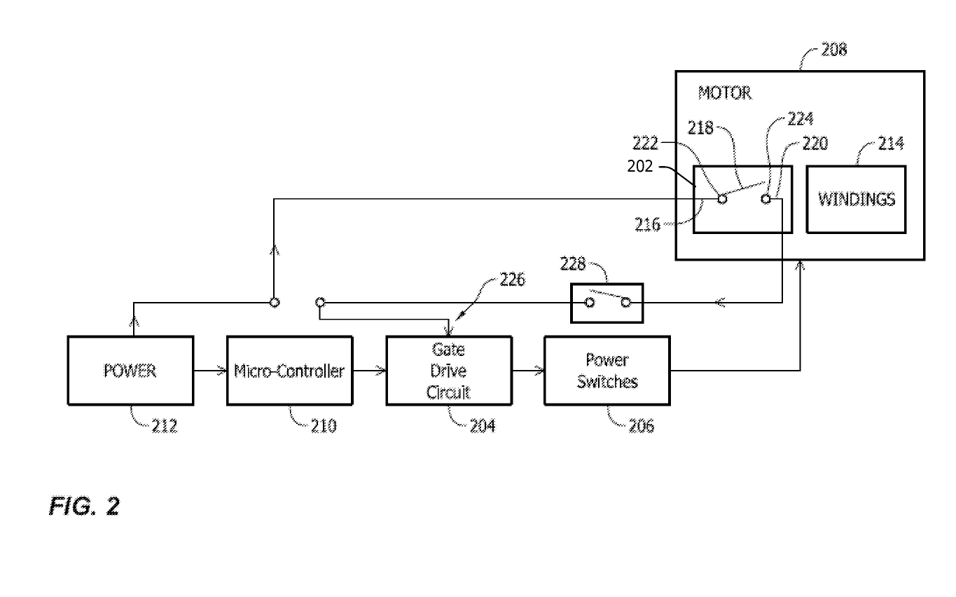

FIG. 2 is a block diagram of an exemplary motor assembly 200 that includes a thermal protection device 202. In the exemplary embodiment, thermal protection device 202 may be similar to thermal protection device 80 (shown in FIG. 1). Motor assembly 200 includes a motor controller 203 having a gate drive circuit 204 coupled to least one or more power switches 206. Power switches 206 are coupled to an electric motor 208, which may be similar to motor 10 (shown in FIG. 1). A microcontroller 210 is coupled to an input of gate drive circuit 204 and is configured to transmit control signals to gate drive circuit 204.

In the exemplary embodiment, a power supply 212 is coupled to gate drive circuit 204 and to microcontroller 210. Power supply 212 is internal to motor assembly 200 and derives a DC voltage from an AC input power source (not shown). Power supply 212 is a low-voltage power supply configured to provide a low DC voltage (i.e., less than 50V) to gate drive circuit 204. Microcontroller 210 retrieves stored programming data from a memory, and based on the power output by power supply 212, transmits control signals to gate drive circuit 204. Gate drive circuit 204 uses the control signals from microcontroller 210 to apply the low DC voltage to power switches 206. By switching the low DC voltage rapidly using power switches 206, gate drive circuit 204 generates a high DC voltage (i.e., larger than 50V), or an effective AC voltage, that operates electric motor 208.

In the exemplary embodiment, thermal protection device 202 is coupled between power supply 212 and gate drive circuit 204. Thermal protection device 202 is a temperature responsive device that is physically positioned adjacent to a winding 214 of electric motor 208 and is responsive to heat generated by current flowing through thermal protection device 202 and winding 214. Thermal protection device 202 is configured for 50 volt DC rated operation. Thermal protection device 202 includes a first conductor 216, an internal switch 218, and a second conductor 220. First conductor 216 is coupled to an output of power supply 212. Internal switch 218 includes a first side 222 coupled to first conductor 216 and a second side 224 coupled to second conductor 220. Second conductor 220 is coupled to second side 224 and to an input 226 of gate drive circuit 204. In one embodiment, internal switch 218 is a metallic material that electrically couples first conductor 216 to second conductor 220. The metallic material is configured to melt at a predetermined temperature, causing first conductor 216 to become uncoupled from second conductor 220.

In the exemplary embodiment, thermal protection device 202 increases in temperature according to motor winding 214 temperature. Internal switch 218 opens when motor winding 214 temperature exceeds the threshold temperature value to disconnect the power supply from the gate drive circuit. When an operating temperature of thermal protection device 202 exceeds a predetermined threshold, thermal protection device 202 transitions from an ON (closed) state to an OFF (open) state. When in the ON state, an electrical circuit through from power supply 212 to gate drive circuit 204 is completed through thermal protection device 202, thereby enabling gate drive circuit 204 to provide power to power switches 206. When in the OFF state, the electrical circuit is broken between power supply 212 and gate drive circuit 204 through thermal protection device 202 to prevent damage to electric motor 208 due to overheating of winding 214. Without power from power supply 212, gate drive circuit 204 cannot turn on power switches 206 and electric motor 208 shuts down.

In the exemplary embodiment, thermal protection device 202 is an automatic reset device such that as thermal protection device 202 cools in the OFF state, thermal protection device 202 resets and completes the circuit between power supply 212 and gate drive circuit 20. Thus, thermal protection device 202 cycles motor power on and off by cycling between the ON and OFF states, respectively. In an alternative embodiment, thermal protection device 202 is a one-shot device that does not reset once entering the OFF state.

In some embodiments, motor assembly 200 includes a second thermal protection device 228 that is electrically coupled to second side 224 of internal switch 218 and an input of gate drive circuit 204. Second thermal protection device 228 is a temperature responsive device that is physically positioned adjacent to power switches 206 and is responsive to heat generated by current flowing through second thermal protection device 228 and power switches 206. Second thermal protection device 228 operates similarly to thermal protection device 202 and may be used alone or in combination with thermal protection device 202.

The thermal protection devices and methods described herein may be implemented using computer programming or engineering techniques including computer software, firmware, hardware or any combination or subset thereof, wherein the technical effect may include at least one of: (a) electrically coupling a thermal protection device between a power supply and a gate drive circuit for driving the motor; and (b) disconnecting, using the thermal protection device, the power supply from the gate drive circuit when a temperature measured by the thermal protection device exceeds a threshold temperature value.

The term processor, as used herein, refers to central processing units, microprocessors, microcontrollers, reduced instruction set circuits (RISC), application specific integrated circuits (ASIC), logic circuits, and any other circuit or processor capable of executing the functions described herein.

As used herein, an element or step recited in the singular and preceded with the word “a” or “an” should be understood as not excluding plural elements or steps, unless such exclusion is explicitly recited. Furthermore, references to “example implementation” or “one implementation” of the present disclosure are not intended to be interpreted as excluding the existence of additional implementations that also incorporate the recited features.

As compared to known thermal protection devices and methods for protecting a motor, the thermal protection devices and methods described herein facilitate coupling/uncoupling a low DC voltage power supply of an electric motor to a gate drive circuit of the electric motor. Rather than coupling/uncoupling a high DC voltage output from the power switches to the motor windings with a thermal protector as in known systems, which typically exceeds the power rating of the thermal protector or necessitates the use of a larger, more costly thermal protector, the thermal protection device described herein enable uncoupling of the low DC voltage supply from the gate drive circuit before the DC voltage is switched to a high DC voltage for driving the motor. The thermal protection device is positioned adjacent a motor winding and opens an internal switch when motor winding temperature exceeds a predetermined threshold value to protect the motor from excessive winding temperatures. When the temperature lowers below the predetermined threshold value, the thermal protection device recouples the low DC voltage power supply to the gate drive circuit to resume motor operation. Accordingly, the thermal protection device provides a low-cost method for protecting a motor from excessive winding temperatures while operating at the proper voltage rating, resulting in safer operation for a user.

Exemplary embodiments of systems and methods for protecting a motor are described herein. The systems and methods described herein are not limited to the specific embodiments described herein, but rather, components of the systems and/or steps of the methods may be utilized independently and separately from other components and/or steps described herein.

This written description uses examples to provide details on the disclosure, including the best mode, and also to enable any person skilled in the art to practice the disclosure, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A thermal protection device for a motor, said thermal protection device electrically coupled between a power supply and a gate drive circuit for driving the motor, said thermal protection device positioned onboard the motor adjacent a motor winding, said thermal protection device configured to disconnect the power supply from the gate drive circuit when a motor winding temperature measured by said thermal protection device exceeds a threshold temperature value.

2. The thermal protection device of claim 1, further configured to couple the power supply to the gate drive circuit when the measured temperature is below the threshold temperature value.

3. The thermal protection device of claim 1, wherein said thermal protection device is coupled to a low direct current (DC) voltage power supply configured to output a DC voltage less than about 50 volts.

4. (canceled)

5. The thermal protection device of claim 1, further configured to:
monitor the motor winding temperature; and
open an internal switch when the motor winding temperature exceeds the threshold temperature value to disconnect the power supply from the gate drive circuit.

6. The thermal protection device of claim 5, further configured to close the internal switch when the motor winding temperature falls below the threshold temperature value to reconnect the power supply to the gate drive circuit.

7. The thermal protection device of claim 4, further configured to interrupt a flow of DC voltage to the gate drive circuit to protect the motor from excessive winding temperatures.

8. The thermal protection device of claim 1, wherein said thermal protection device is positioned adjacent to at least one power switch of the motor.

9. The thermal protection device of claim 8, further configured to:
increase in temperature according to the at least one power switch temperature; and
open an internal switch when the at least one power switch temperature exceeds the threshold temperature value to disconnect the power supply from the gate drive circuit.

10. A method of protecting a motor, comprising:
positioning a thermal protection device onboard the motor adjacent a motor winding;
electrically coupling the thermal protection device between a power supply and a gate drive circuit for driving the motor; and
disconnecting, using the thermal protection device, the power supply from the gate drive circuit when a motor winding temperature measured by the thermal protection device exceeds a threshold temperature value.

11. The method of claim 10, further comprising coupling the power supply to the gate drive circuit when the measured temperature is below the threshold temperature value.

12. The method of claim 10, further comprising positioning the thermal protection device adjacent to least one power switch of the motor.

13. The method of claim 10, further comprising:
monitoring a temperature of at least one of the motor winding and the at least one power switch of the motor using the thermal protection device; and
opening an internal switch when the measured temperature exceeds the threshold temperature value to disconnect the power supply from the gate drive circuit.

14. The method of claim 10, further comprising closing the internal switch when the motor winding temperature falls below the threshold temperature value to reconnect the power supply to the gate drive circuit.

15. The method of claim 10, further comprising:
coupling a first conductor of the thermal protection device to an output of the power supply;
coupling a first side of an internal switch to the first conductor; and
coupling a second conductor to a second side of the internal switch and to an input of the gate drive circuit.

16. A motor controller configured to be coupled to a motor, said motor controller comprising:
a gate drive circuit configured to receive power from a power supply and output a switching signal; and
a thermal protection device electrically coupled between the power supply and said gate drive circuit, said thermal protection device positioned onboard the motor adjacent a motor winding, said thermal protection device configured to disconnect the power supply from said gate drive circuit when a motor winding temperature measured by said thermal protection device exceeds a threshold temperature value.

17. (canceled)

18. The motor controller of claim 17, wherein said thermal protection device is further configured to:
monitor the motor winding temperature; and
open an internal switch when the motor winding temperature exceeds the threshold temperature value to disconnect the power supply from the gate drive circuit.

19. The motor controller of claim 16, wherein said thermal protection device is further configured to interrupt a flow of DC voltage to the gate drive circuit to protect the motor from excessive winding temperatures.

20. The motor controller of claim 16, wherein said thermal protection device is positioned adjacent to at least one power switch of the motor.
